(19) United States
(12) Patent Application Publication
(10) Pub. No.: US 2026/0059300 A1
(43) Pub. Date: Feb. 26, 2026

(54) METHOD AND APPARATUS FOR PRIVACY MANAGEMENT IN A WIRELESS NETWORK

(71) Applicant: CANON KABUSHIKI KAISHA, Tokyo (JP)

(72) Inventors: Patrice NEZOU, LIFFRE (FR); Stéphane BARON, LE RHEU (FR); Julien SEVIN, SAINT AUBIN DU CORMIER (FR)

(21) Appl. No.: 19/105,732

(22) PCT Filed: Aug. 16, 2023
(86) PCT No.: PCT/EP2023/072622

§ 371 Date: Feb. 21, 2025

(30) Foreign Application Priority Data
Aug. 26, 2022 (GB) 2212468.9

(51) Int. Cl. H04W 12/02; H04W 12/08; H04W 76/14

(52) U.S. Cl. CPC H04W 12/02; H04W 12/08; H04W 76/14

(57) ABSTRACT

The present invention concerns a method for managing a privacy level in a wireless network comprising an access point, AP, station and at least one non-AP station, the method comprising by a first station, either a non-AP station or the AP station sending, to a second station a message comprising an information indicating a set of privacy enhancement, PE, parameters to be obfuscated, the set of PE parameters corresponding to a privacy level requested by the first station, the second station being the AP if the first station is a non-AP station, the second station being a non-AP station if the first station is the AP, and receiving from the second station a response indicating whether the second station accepts the requested privacy level.

### FIELD OF THE INVENTION

The present disclosure concerns a method and a device for managing privacy in wireless networks. It concerns more particularly the management of privacy profiles during wireless communications.

### BACKGROUND OF INVENTION

The approaches described in this section could be pursued but are not necessarily approaches that have been previously conceived or pursued. Therefore, unless otherwise indicated herein, the approaches described in this section are not prior art to the claims in this application and are not admitted prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE) provides a great number of mechanisms for wireless communications between stations.

Today, the evolution of wireless systems has brought privacy concerns at the forefront, driven by user demand and requirements of the General Data Protection Regulation (GDPR). The global wireless industry is faced with the growing need to protect users' personally identifiable information from increasingly sophisticated user tracking and user profiling activities, while continuing to improve wireless services and the user experience.

In the context of Wi-Fi networks, the Media Access Control (MAC) address, or EUI-48 address, of a user device has been rapidly identified as a key privacy parameter which can be used to track a user without his consent. The IEEE 802.11 working group has then proposed a procedure consisting of dynamically modifying the MAC address of the user device. This mechanism, called Randomized and Changing MAC (RCM) procedure, has been originally introduced as a privacy enhancing feature in the 802.11aq Pre-Association Service Discovery Task Group and finally included in the standard IEEE Std 802.11-2020. The RCM procedure is an obfuscation procedure applying to the MAC address. It comprises periodical change of the MAC address of a non-AP station (i.e. a station which is not an access point) to a random value, while the non-AP station (STA) is not associated to a network (or, equivalently, to an access point).

Changing only the MAC addresses is a first step to improve the privacy but it is often not sufficient, other elements, referred to as Personally Identifiable Information (PII) or privacy parameters, shall be also obfuscated. Obfuscation is typically done by dynamically modifying the parameter in order to be not identifiable and/or not traceable. For instance, for the RCM procedure specified in the standard IEEE Std 802.11-2020, every time the MAC address of the non-AP STA is changed to a new random value, counters in all Sequence Number (SN) spaces used to identify each transmitted frame (MSDU or MMPDU) shall be reset randomly as well the seeds of the scramblers used at PHY level for shuffling the frame data payload before transmission.

Since 2019, a specific IEEE 802.11bi task group is in charge of proposing new technical features beyond the RCM procedure in order to enhance the privacy in 802.11. At the current stage, it specified a set of privacy requirements which implies the consideration of new privacy parameters, referred to Privacy Enhancements (PE) parameters, relative to AP and/or non-AP STA, when the non-AP STA is associated or not, and that these multiple PE parameters shall be simultaneously obfuscated. This may lead to an unacceptable implementation cost and complexity. It is desirable to manage handling of the PE parameters in a BSS to ensure that communications are performed at desired privacy levels while reducing implementation cost and complexity.

### SUMMARY OF THE INVENTION

The present invention has been devised to address one or more of the foregoing concerns.

According to a first aspect of the invention there is provided a method for managing a privacy level in a wireless network comprising an access point, AP, station and at least one non-AP station, the method comprising by a first station, either a non-AP station or the AP station:
sending to a second station a message comprising an information indicating a set of privacy enhancement, PE, parameters to be obfuscated, the set of PE parameters corresponding to a privacy level requested by the first station; and
receiving from the second station a response indicating whether the second station accepts the requested privacy level.

In an embodiment, the message further comprises an indication of the PE parameters supported by the first station.

In an embodiment, the information indicating a set of PE parameters is an information element comprising for each possible PE parameter an indication whether the PE parameter belongs to the set of PE parameters corresponding to the requested privacy level.

In an embodiment, the information indicating a set of PE parameters is an information element comprising for at least one privacy profile, a privacy profile corresponding to a set of PE parameters, whether the privacy profile corresponds to the requested privacy level.

In an embodiment, the message further comprises a privacy alignment indication indicating whether the requested privacy level must apply to the stations belonging to a group of stations connected to the AP station.

In an embodiment, the group of stations connected to the AP station comprises all the stations connected to the AP station.

In an embodiment, the first station is a non-AP station, the message is a management frame sent during the association of the non-AP station and the method further comprises:
receiving a message indicating the refusal of the association from the AP station when the AP does not accept the requested privacy level.

In an embodiment:
the first station is a non-AP station;
the privacy alignment indication indicates that the requested privacy level must apply to the group of stations; and wherein the method further comprises by the AP station:
broadcasting a message requesting the requested privacy level to all the stations of the group of stations.

In an embodiment, the method further comprises by the AP station:
refusing the association of the first station when at least one station of the group of stations cannot meet the requested privacy level.

In an embodiment, the method further comprises by the AP station:
de-associating the stations in the group of stations that cannot meet the requested privacy level; and
accepting the association of the first station.

In an embodiment:
the first station is the AP station; and
the message is an action frame.

In an embodiment, the method further comprises:
de-associating the second station when it cannot meet the requested privacy level.

According to another aspect of the invention there is provided a method for managing a privacy level in a wireless network comprising an access point, AP, station and at least one non-AP station, the method comprising by a station either a non-AP station or the AP station:
sending to another station a message comprising an information indicating a set of privacy enhancement, PE, parameters supported by the station.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a computer-readable storage medium storing instructions of a computer program for implementing a method according to the invention.

According to another aspect of the invention there is provided a computer program which upon execution causes the method of the invention to be performed.

According to another aspect of the invention there is provided a first station device for managing a privacy level in communication with a second station in a wireless network comprising an access point, AP, station and a non-AP station, the first station device being the non-AP station or the AP station, the first station device comprising a processor configured for:
sending to the second station a message comprising an information indicating a set of privacy enhancement, PE, parameters to be obfuscated, the set of PE parameters corresponding to a privacy level requested by the first station; and
receiving from the second station a response indicating whether the second station accepts the requested privacy level.

According to another aspect of the invention there is provided a station device for managing a privacy level in a wireless network comprising an access point, AP, station and at least one non-AP station, the station device being either a non-AP station or the AP station, the station device comprising a processor configured for:
sending to another station a message comprising an information indicating a set of privacy enhancement, PE, parameters supported by the station.

According to another aspect of the invention there is provided a privacy information element to be inserted in a message for managing a privacy level in a wireless network comprising an access point, AP, station and at least one non-AP station, wherein:
the privacy information element comprises an information indicating a set of privacy enhancement, PE, parameters to be obfuscated and/or supported by a station.

In an embodiment, the privacy information element comprises for each PE parameter a status comprising:
a capable field indicating whether the PE parameter is supported; and
an enabled filed indicating whether the PE parameter is to be obfuscated.

In an embodiment, the privacy information element comprises a profile identifier, the profile corresponding to a set of PE parameter, the privacy information element comprising for the profile a status comprising:
a capable field indicating whether the PE parameter is supported; and
an enabled filed indicating whether the PE parameter is to be obfuscated.

According to another aspect of the invention there is provided a privacy information element to be inserted in a message for managing a privacy level in a wireless network comprising an access point, AP, station and at least one non-AP station, wherein:
the privacy information element comprises a set of PE parameters and a profile identifier for defining a profile corresponding to the set of PE parameters.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an example of a network system in which embodiments of the invention may be used;

FIGS. 2a, 2b, 2c and 2d illustrate frame formats characterizing the PE parameters in an embodiment of the invention;

FIGS. 3a and 3b illustrate the main steps of a method for operating an association procedure comprising the privacy feature in an embodiment of the invention;

FIG. 3c illustrates a table describing the error return code associated to the association procedure comprising the privacy feature in an embodiment of the invention;

FIG. 4 illustrates frame formats characterizing an action frame;

FIGS. 5a and 5b illustrate the main steps of a method for operating a method for modifying the privacy level by a non-AP STA in an embodiment of the invention;

FIG. 6 illustrates the main steps for operating a method for modifying the privacy level by an AP in an embodiment of the invention;

FIG. 7 illustrates an example of a communication device of a wireless network, configured to implement at least one embodiment of the invention.

### DETAILED DESCRIPTION OF THE INVENTION

According to embodiments, the invention proposes a global procedure to share between a non-AP STA and an AP their PE parameters during the association procedure. According to embodiments, a station, either AP or non-AP may request a change of the privacy level after the association. According to embodiments, a station, either AP or non-AP, may request that the entire BSS, or a group of stations in the BSS, adopts a certain level of privacy.

These procedures make possible to agree on a set of PE parameters to apply between the AP and a non-AP station. The set of PE parameters corresponds to a level of privacy that may be required by the non-AP station or by the AP station.

In this document, a station, either AP or non-AP, is said to support a PE parameter when the station is capable of applying an obfuscation procedure to this PE parameter. A PE parameter is said to be enabled when the obfuscation procedure is activated by the station for this parameter. For example, an AP station is said to support the PE parameter corresponding to the MAC address of the AP station when the AP station is capable of handling the obfuscation of its MAC address.

Similarly, a station, either AP or non-AP, is said to support a PE parameter of the other station when the station is capable of handling an obfuscation procedure of this parameter applied by the other station. For example, an AP station is said to support the PE parameter corresponding to the MAC address of a non-AP station when the AP station is capable of handling the obfuscation of the MAC address of the non-AP station applied by the non-AP station.

The AP and a non-AP station associated with the AP need to agree on the set of PE parameters used in their communication. The AP and the non-AP station may first share their capabilities, during association phase for example, regarding the supported PE parameters. The outcome of the sharing may be an agreement on a set of PE parameters supported by both the AP and the non-AP station. The outcome may also be an absence of support of a common set of PE parameters. Note that a non-AP station may still associate with the AP as long as the AP does not require enablement of a PE parameter that is not supported by the station (i.e. the station is not capable of handling). The AP and the non-AP station may secondly negotiate the PE parameters to be enabled for communication, either at association phase or while the two stations are already associated.

IEEE 802.11bi task group has specified two sets of PE features. The first one, referred to as set of Client Privacy Enhancements (CPE) features, prevents the identification and the tracking of a Client (non-AP STA). The second one, referred to as set of BSS Privacy Enhancements (BPE) features, prevents the identification and the tracking of a BSS. From these, a CPE-capable AP is referred to as CPE AP and a CPE-capable non-AP STA is referred to as CPE non-AP STA or CPE Client. Similarly, a BPE-capable AP is referred to as BPE AP and a BPE-capable non-AP STA is referred to as BPE non-AP STA or BPE Client.

Typically, the CPE features are initiated by a CPE Client, referring to as initiating CPE client, and the BPE features by the BPE AP. The CPE features involve the simultaneous obfuscation of multiple PE parameters, referred to as CPE parameters. Similarly, the BPE features involve the simultaneous obfuscation of multiple PE parameters, referred to as BPE parameters. This way, each PE parameter is obfuscated either by the non-AP station or the AP station according to a dedicated obfuscation procedure associated with this PE parameter. This obfuscation procedure typically implies a random change of the parameter, but it may differ according to the nature of the PE parameter.

In this document, PE parameters refers indistinctly to CPE parameters and/or BPE parameters. The detail of the obfuscation procedure associated with each PE parameter is out of the scope of the present document.

For the sake of illustration, CPE parameters currently identified by the IEEE 802.11bi task group are the following:

The MAC address of the CPE Client for over-the-air (OTA) communications, referred to as OTA MAC Address, which is indicated either in the Transmitter Address (TA) field or the Receiver Address (RA) field of the IEEE 802.11 frames (corresponding to address 2 or 3). Optionally, the CPE Client may have several OTA MAC addresses, each one used for a given purpose (data, measurement . . . ). A MAC address, or EUI-48 address, of a device is an Extended Unique Identifier (EUI) composed of 48 bits. It can be administered universally or locally. A universally administered address is uniquely assigned to the device by the manufacturer. On the contrary, a locally administered address is assigned to the device by software or network administrator, and replaces the physical burned-in address. The second-least-significant bit of the first octet of the MAC address, i.e. the seventh bit of the address, also referred to as “U/L bit” (for “Universal/Local bit”), indicates whether it is universally (when set to 0) or locally (when set to 1) administered. The least-significant bit of the first octet of the MAC address, i.e. the eighth bit of the address, also referred to as “I/G bit” (for “Individual/Group bit”), indicates whether the frame is sent to only one receiving device (when set to 0, indicating unicast transmission) or to a plurality of devices (when set to 1, indicating multicast transmission).

The Sequence Number (SN) which is included in the Sequence Number field of the Sequence Control field of the MAC Header of an 802.11 frame (MSDU, A-MSDU, or MMPDU). It is a 12-bit field. The sequence number is incremented for each frame transmission and remains constant in case of a frame retransmission.

The Packet Number (PN) which is included in the Packet Number field of the CCMP Header of the plaintext MAC payload of the frame. It is a 48-bit packet number. It is used for the encryption of the frame and allows to uniquely identify the frame being transmitted for replay detection. The packet number is incremented for each frame transmission and remains constant in case of a frame retransmission.

The Association Identifier AID (AID) which is a unique identifier assigned by an AP to a non-AP during the association. It is a 16-bit field and it is included in many frames for different usages as the power saving or the resources allocation in the MU OFDMA.

The Scrambler Seed which corresponds to the seed used by the PLCP/OFDM PHY DATA scrambler to initialize its initial state (802.11-2020-subclause 17.3.5.5). It corresponds to a 7-bits parameter

The BPE parameters are the same for as the CPE parameters for the BPE Clients. For the BPE AP, the IEEE 802.11bi task group are identified the following:

The OTA MAC address of BPE AP which is indicated either in the Transmitter Address (TA) field or Receiver Address (RA) field of the IEEE 802.11 frames, corresponding to address 2 or 3. Optionally, the BPE AP may have several OTA MAC addresses, each one used for a given purpose (data, measurement . . . ).

The Scrambler Seed which corresponds to the seed used by the PLCP/OFDM PHY DATA scrambler to initialize its initial state (802.11-2020-subclause 17.3.5.5). It corresponds to a 7-bits parameter.

The Beacon Interval which corresponds to the difference between two Target Beacon Transmission Times (TBTT), a TBTT being the time at which an AP shall send its beacon frame. The beacon Interval is given in Time Units (TU), a TU being equal to 1024 microseconds. It is a 16-bit field set to the number of TU between Beacon transmissions and it is included in the Beacon Interval field of the beacon frames.

Obviously, the above list of CPE/BPE parameters is not exhaustive and other CPE/BPE parameters can be considered. For instance, as a BPE parameter, the BSS color which has been introduced by IEEE 802.11ax task group used to identify a BSS may also be considered. It is included in the BSS Color field of the BSS Color Information of HE Operation element which is included in Beacon, Probe Response and (Re) Association frames. It is a 6-bits parameter.

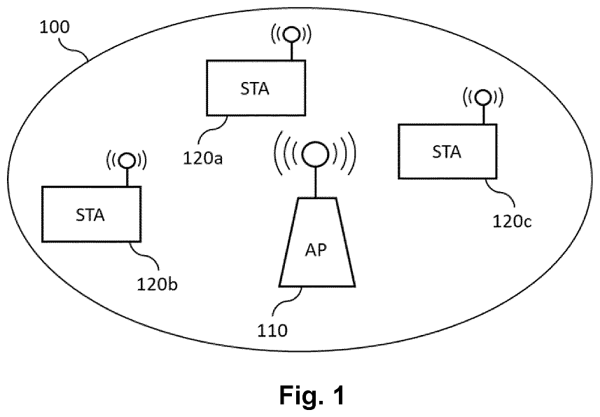

FIG. 1 represents an 802.11 network (i.e. a Wi-Fi network) system 100 comprising four wireless devices: an access point (AP) 110 and three non-AP stations (non-AP STAs) 120a, 120b, 120c. Of course, the number of non-AP STAs 120a, 120b, 120c may be different from three. The AP 110 provides wireless connections between the non-AP STAs 120a, 120b, 120c and a wider network, such as the Internet. The connection of a non-AP STA 120a, 120b, 120c to the AP 110 is performed by a standardized process called association. Once a non-AP STA 120a, 120b, 120c is associated with the AP 110, the non-AP STA 120a, 120b, 120c can send data to the network and receive data from the network through the AP 110.

The AP 110 may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance a broadband remote access server (BRAS).

A non-AP STA 120a, 120b, 120c may comprise, be implemented as, or known as a subscriber station, a subscriber unit, a mobile station (MS), a remote station, a remote terminal, a user terminal (UT), a user agent, a user device, a user equipment (UE), a user station, or some other terminology. In some implementations, a non-AP STA 120a, 120b, 120c may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA 120a, 120b, 120c may be a wireless node. Such wireless node may provide, for example, connectivity for or to a network (e.g., a wide area network such as the Internet or a cellular network) via a wired or wireless communication link.

The AP 110 manages a set of STAs that together organize their accesses to the wireless medium for communication purposes. All the STAs, AP 110 and non-AP STA 120a, 120b, 120c, form a service set, which may be referred to as basic service set, BSS although other terminology can be used. It is noted that the AP 110 may manage more than one BSS: each BSS is thus uniquely identified by a specific basic service set identifier (BSSID) and managed by a separate virtual AP implemented in the physical AP 110.

In order to ensure the user privacy, the AP STA 110 and the non-AP STA 120a, 120b, 120c have been configured with a dot11MACPrivacyActivated set to true. This is a Management Information Base (MIB) variable controllable by an external management entity to define whether the non-AP STA can apply, when the variable is set to true, specific mechanisms for enhancing the privacy at MAC level, including the RCM procedure, or not when the variable is set to false.

According to some embodiments of the invention, the AP STA 110 is a CPE AP and the non-AP STA 120a, 120b, 120c are CPE Clients. According to other embodiments of the invention, the AP STA 110 is a BPE AP and the non-AP STA 120a, 120b, 120c are BPE Clients. According to other embodiments, the AP STA 110 is both a CPE and BPE AP and the non-AP STA 120a, 120b, 120c are both CPE and BPE Clients.

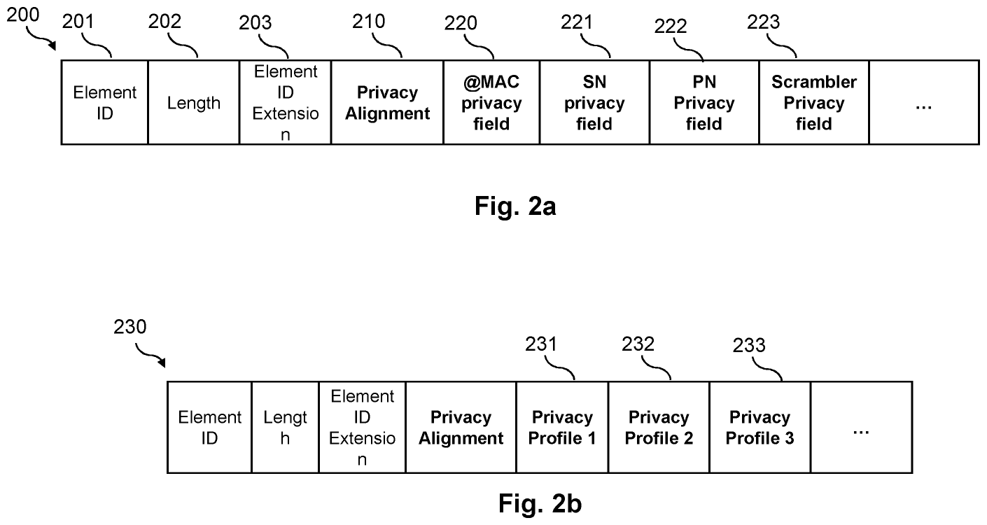

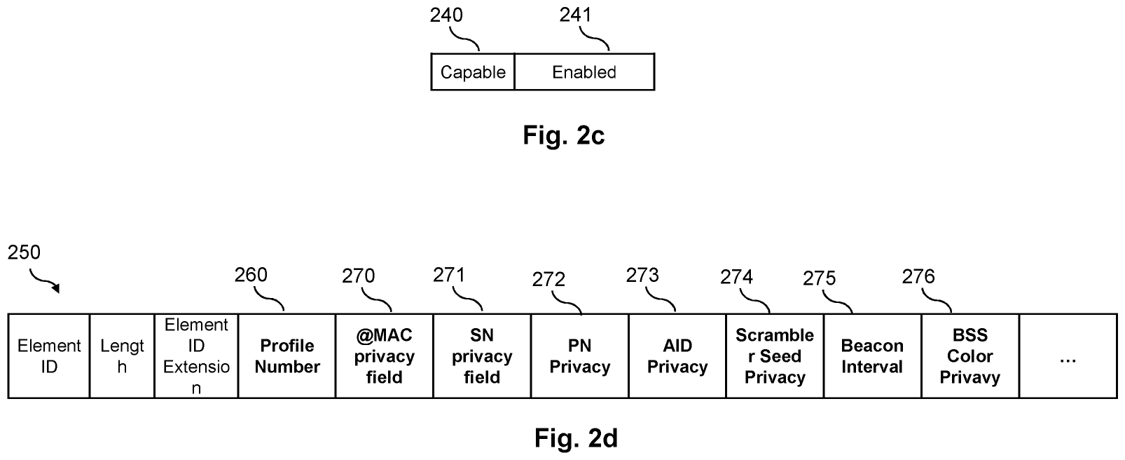

FIGS. 2a, 2b, 2c and 2d illustrate frame formats characterizing the privacy parameters according to embodiments of the invention.

FIG. 2a illustrates in one embodiment an information element (IE) dedicated to the management of all Privacy Enhancement (PE) parameters, either CPE or BPE. An information element (IE) can be included in any management frames such as frames used during the association procedure. The privacy IE 200 allows to define the status of each PE parameter considering the capability of a station to handle this PE parameter and its enabled status indicating whether the obfuscation of this PE parameter is activated or not.

The privacy IE 200 is composed of:
an Element ID 201 identifying the information element;
a Length field 202 defining the length of the information element;
an Element ID extension field 203 identifying the extended information element;
a Privacy Alignment field 210 that can be used by a non-AP STA to request the AP to force at least the support of the same PE parameters for all other associated non-AP STAs;
Each privacy field 220, 221, 222, 223 defines the status of a PE parameter, for example respectively the OTA MAC address, the Sequence Number, the Packet number, the Scrambler Seed and any other PE parameters. The status of a PE parameter, as described in FIG. 2c, is composed of:
   a “capable” field that is set to 1 when the non-AP STA or AP supports the PE parameter, 0 otherwise;
   an “enabled” field that is set to 1 when the non-AP STA or AP requires or confirms the obfuscation of the PE parameter, 0 otherwise. In some embodiments, the 0 value may also be used to require or confirm stopping the obfuscation when it is already activated.

FIG. 2b illustrates another embodiment of a privacy IE 230. For this embodiment, the privacy field 220, 221, 222, 223 describing the status of one PE parameter is replaced by a Privacy Profile field 231, 232, 233. Each Privacy Profile field is associated with a privacy profile corresponding to a set of PE parameters. The privacy profile may be predefined or dynamically defined as detailed below in relation to FIG. 2d. This embodiment is especially useful in the scope of the WiFi Alliance that often specifies predefined profiles for STAs. It allows the management, at once, of a predefined set of PE parameters corresponding to a profile. This embodiment is therefore typically more compact than the first embodiment of FIG. 2a where each PE parameter is handled independently. This embodiment allows to reduce the overhead of the previous embodiment by defining several privacy profiles. The privacy Profile field is also composed of the same subfields illustrated in FIG. 2c to manage the capability and the enabled status of the privacy profile. The station is said to support the profile when the station can handle the obfuscation of all the PE parameters of the set of PE parameters corresponding to the profile. The station is said to have enabled the profile when the obfuscation of all the PE parameters of the profile is enabled, meaning that the obfuscation of all the PE parameters of the profile is activated.

FIG. 2d illustrates an embodiment of an information element (IE) dedicated to the definition of a Privacy Profile. The privacy profile set IE 250 defines which PE parameters 270, 271, 272, 273, 274, 275, 276 are comprised in the profile and associates this set of PE parameters to a Profile number (or identifier) 260. This IE can be included, as any information element defined the 802.11 standard, in any management frames or action frames. Management frames are frames used to manage the BSS. Action frames are management frames that trigger an action to happen. An AP can use these privacy profile set IEs 250 to advertise to all associated non-AP STAs the valid privacy profiles for the BSS. Afterwards, the validated privacy profiles can be used by the AP to manage the set of validated privacy profiles using, for example, the information element illustrated by FIG. 2b. These information elements 2b and 2d allows the definition and the use of any profile beyond the predefined ones.

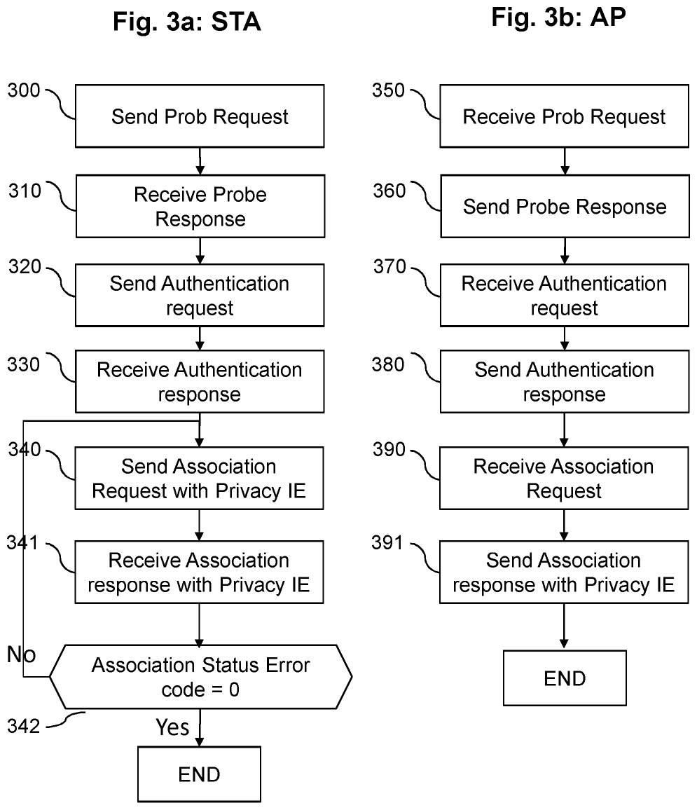

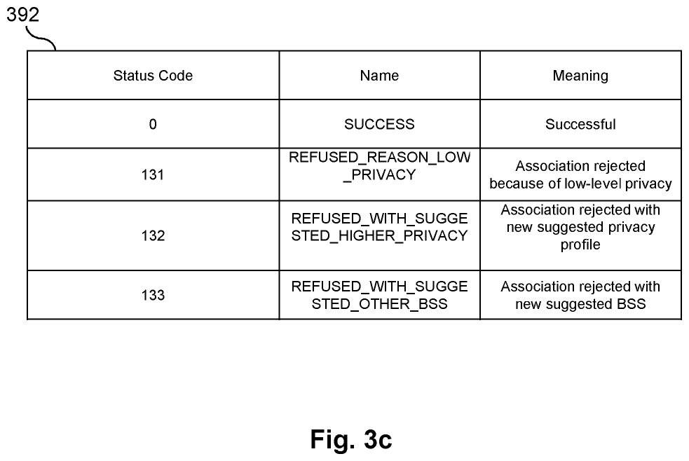

FIGS. 3a and 3b illustrate the main steps of a method for operating an association procedure implying the privacy feature in an embodiment of the invention. This method gives an example of usage of the information elements described in relation with FIGS. 2a-2d. The association procedure may be used by the AP and a STA to share their capabilities and to find an agreement on the enabled features of each part.

The association comprises three main parts illustrated by FIGS. 3a and 3b, the probe exchange, the authentication exchange, and the association exchange.

The probe exchange begins when a STA sends a probe request, in a step 300, containing a set of IEs characterizing the STA itself and asking some properties of the AP. The Probe exchange allows a STA to scan the neighbor BSSs and their capabilities. The probe response sent by the AP, in a step 360, provides essential properties of the BSS driven by the AP.

In a step 350, the AP receives the probe request from the non-AP station. In a step 360, the AP sends a probe response to the non-AP station. In a step 310, the non-AP station receives the probe response from the AP. These exchanges are called the probe exchange. The probe exchange allows a STA to scan the neighbour BSSs and their capabilities. These capabilities may comprise the capabilities regarding the privacy management. The probe response sent by the AP in step 360 provides essential properties of the BSS driven by the AP. It may include the PE parameters policy of the BSS.

The authentication exchange is the exchange during which the STA and the AP exchanges their identity at a mutually acceptable level. These exchanges comprise the send of an authentication request in step 320. The authentication request is received by the AP in a step 370. The AP sends an authentication response in step 380. This authentication is received by the non-AP station in step 330. Some parameters as, for example, encryption keys may be exchanged during this phase during steps 320, 330, 370, 380. In some embodiments, information elements related to privacy management may be included in the frames exchanged during the authentication.

The association exchange is the final stage of the association procedure when the AP validates, or not, the membership of the STA in the BSS. Association begins with the STA sending an association request in a step 340 to the AP. The association request is received by the AP in a step 390. The AP sends an authentication response to the non-AP station in a step 391. The association response is received by the non-AP station in a step 341. The AP responds with an association response 341, 391. If the station is admitted, the association response is provided with an association status error code set to value 0 indicating the success of the association. If the station is not admitted, the association response is provided with an association status error code set to a non-zero value. The association status error code may indicate a reason of the non-admission of the non-AP station by the AP. In embodiments, as indicated in step 340, 341, 390, 391, the association request and response frames contain a set of IEs characterizing the PE parameters of the STA itself and requesting the PE parameters and/or some properties of the AP. Consequently, the association status error code may be related to privacy management. The capability exchange is finalized at this stage and the AP informs the STA of specific parameters within the BSS. In some embodiments, information elements related to privacy management may be included in the frames exchanged during association.

Probe request/response frames, authentication request/response frames and association request/response frames are management frames. As such, they may contain different information elements including the information elements related to privacy management. So, any kinds of privacy IEs described in FIGS. 2a, 2b and 2c can be exchanged between a STA and an AP during the association procedure. In one embodiment illustrated by FIGS. 3a and 3b, the privacy information elements are exchanged during the association exchange. The STA may transmit an association request with its privacy information element characterizing the status of the PE parameters that are supported (it means “that may be handled or obfuscated”) by the STA.

As described in FIG. 2c, the status of a PE parameter is divided into 2 parts: the capable field 240 means that the STA is capable of supporting the obfuscation of the corresponding PE parameter, the enabled field 241 means that the STA requests the obfuscation of the corresponding PE parameter to be enabled. The privacy information element of the association request frame can contain some privacy fields with a capable field set to 1 and an enabled field set to 0, and some other privacy fields with a capable field set to 1 and an enabled field set to 1. When a STA sends a privacy information element that contains a privacy field with a capable field set to 1 and a enabled field set to 0, it means that the STA informs the AP that the corresponding PE parameter is supported by the STA but is not asked to be enabled at the time of transmission. When a STA sends a privacy information element that contains a privacy field with a capable field set to 1 and a enabled field set to 1, it means that the STA asks the AP that the corresponding PE parameter is to be obfuscated. When the capable field is set to 0, it means that the station is not capable to handle the obfuscation of the parameter. It is worth noting that the case where the capable field is set to 0 and the enabled field is set to 1 should not happen as a station should not require the obfuscation of a PE parameter if it is not capable of handling this obfuscation.

When all the enabled fields are set to 0, the message corresponds to a simple signalling of the capacities of the station regarding privacy without requesting any level of privacy. This only signalling message does not require a response by the other station.

When a station signals its capabilities regarding the supported PE parameters, all the supported PE parameters are typically signalled. In some embodiments, it may happen that a station signals only some of its capabilities. For example, when responding to a message by a station signalling its own supported PE parameters, the AP may only signal its supported PE parameters in the group of PE parameters supported by the station.

In an embodiment, the capable field is implicit. In this case, the status illustrated by FIG. 2 comprises only the enabled field. In this embodiment, a station does not advertise its complete capabilities to the other side. A request for enabling a PE parameter is made without the knowledge of its support by the other side. In case the other side does not support a PE parameter for which the obfuscation is requested, it may send a response with the enabled field set to 0 for this parameter (or any other type of signalling). This response corresponds to refusing the obfuscation of the PE parameter.

According to embodiments, when one side refuses the obfuscation of a PE parameter requested by the other side, it may lead to a station abandoning the association process or de-associating itself from the BSS if it was already associated. In some cases, it may also lead to the AP refusing the association or de-associating the station if it was already associated.

The AP sends in response an association response frame that may comprise a privacy IE for specifying the PE parameters, that are capable and are enabled or not, to be applied by the STA. The list of PE parameters that were asked to be enabled by the STA can be different from the list of PE parameters that are transmitted by the AP inside the association response frame. Some PE parameters that are only signalled as supported by the STA could be enabled later by the AP when the AP will ask to increase for instance the privacy level.

If the privacy alignment field 210 is set to 1 in the information element sent by the AP, it means that the BSS is subject to a uniform privacy policy where the provided PE parameters are applied to all the other associated STAs. In another embodiment, it means that the provided PE parameters are applied to a predefined group of STAs. In this case, the privacy policy is uniformly applied to the group of STA instead of the whole BSS.

When the privacy alignment field 210 is set to 1 in the information element sent by a non-AP station, it means that the station requests the application of a uniform policy in the BSS or, alternatively in some embodiments, in a group of station, the group being defined by the AP.

When a non-AP station requires a uniform level of privacy to be applied to all stations of the BSS, the AP broadcasts this requirement to all associated non-AP stations. When some connected non-AP stations cannot meet the requested level of privacy, the AP may take the decision to de-associate these non-AP stations. Alternatively, in another embodiment, the AP may decide to refuse the association of the non-AP station that required the level of privacy and keep the already associated stations.

FIG. 3c illustrates a table of association status error codes used in an embodiment of the invention.

If the association status error code of the association response is set to 0 indicating a status called SUCCESS, the privacy level of the STA is acceptable for the AP.

If the association status error code of the association response is set to REFUSED_REASON_LOW_PRIVACY, for example value 131, the association procedure fails, and the STA must resend another association request with a privacy IE comprising other PE parameters. In this case, the association response does not comprise any indication of the PE parameters that may be admissible by the AP.

If the association status error code of the association response is set to REFUSED_WITH_SUGGESTED_HIGHER_PRIVACY, for example value 132, the AP includes in the association response a privacy IE corresponding to suggested PE parameters. To validate its membership in the BSS, the STA must resend another association request frame comprising a privacy IE with the suggested PE parameters.

If the association status error code of the association response is set to REFUSED_WITH_SUGGESTED_OTHER_BSS, for example value 133, the AP suggests to the STA to perform another association procedure in another BSS linked to the AP. For instance, in a multi-link environment, the linked BSS are announced in the multi-link information element.

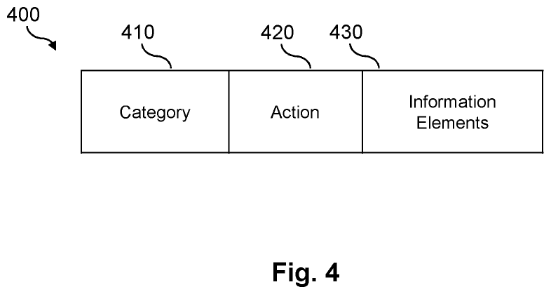

FIG. 4 illustrates a privacy action frame 400 that may be used in the exchanges between an AP and a non-AP station. This privacy action frame 400 is composed of:
a category field 410 set to a predefined value. This value may be defined as a new value for the privacy action frame added in the 802.11-2020 specification, for example value 37;
an action field 420 which may be set to the value 0 for indicating a request and to the value 1 for indicating a response;
A field 430 may contain one or several privacy information elements. These information elements may be used to indicate the set of PE parameters. It may be, for example, the updated set of PE parameters requested by an upper layer of the station.

This privacy action frame is typically used in the exchanges occurring between a non-AP station and an AP station that are already associated to change the level of privacy of their communications.

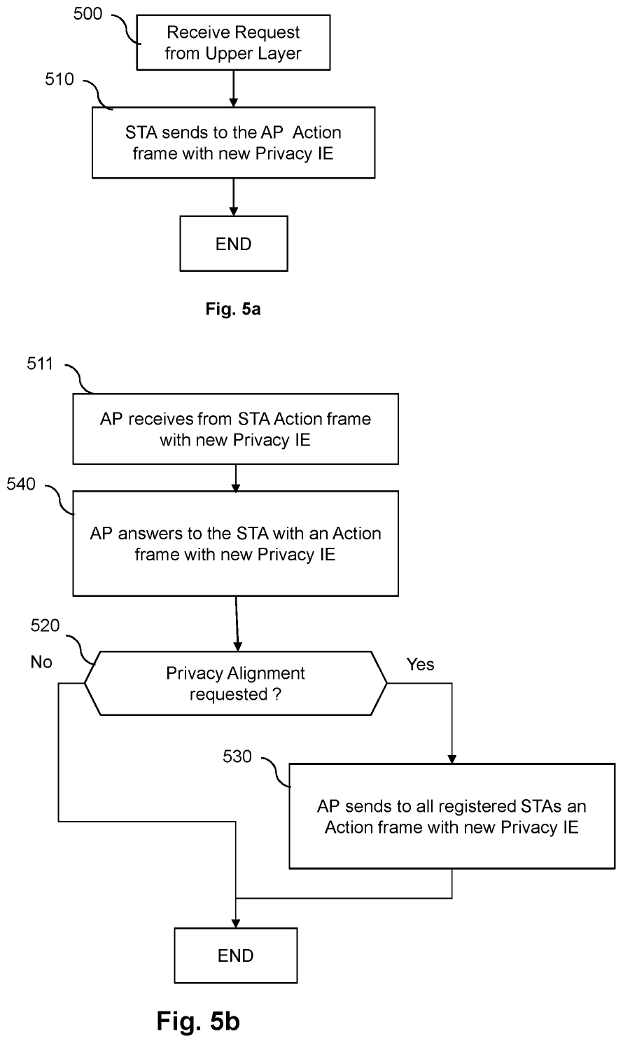

FIGS. 5a and 5b illustrate the main steps of a method for operating a method for modifying the privacy level by a non-AP STA in an embodiment of the invention. This method aims at modifying the level of privacy, meaning the set of PE parameters enabled, between a non-AP station and an AP station. It is assumed that the non-AP station is already associated with the BSS controlled by the AP. An initial level of privacy is therefore already in use between the non-AP and the AP stations.

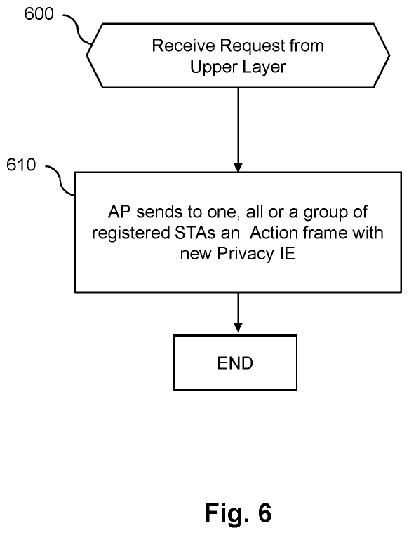

The change of privacy level may be requested by the non-AP station, for example as a requirement of an application running on the non-AP station. This is the case illustrated by FIGS. 5a and 5b. In some cases, the AP may be the station requesting the change as detailed, for example, in relation with FIG. 6.

When a STA is associated to a BSS, the AP has validated a set of PE parameters that are enabled during the association procedure. The STA is linked to upper layer used to manage user applications. If some user application requires a higher privacy level for example, the STA receives a request from upper layer to increase the privacy level in a step 500. Then the STA sends to the AP a privacy action frame, for example an action frame 400 as described in relation with FIG. 4.

Upon the reception of a privacy request action frame in step 511, the AP accepts or not the new set of PE parameters. The AP responds to the received request by sending a privacy action frame in step 540. This privacy response action frame contains a set of PE parameters that will be applied from now on. If the AP has accepted the request, the set of PE parameters in the privacy response action frame corresponds to the set of PE requested by the non-AP station. If the AP refuses the request, the set of PE parameters in the privacy response action frame corresponds to the former set that was used prior to the request, which continues to apply.

In step 520, it is tested if the privacy request action frame contains a privacy IE with a privacy alignment field 210 set to 1. If the test is true, it means that the STA requests that the privacy level requested by the STA is to be applied to all STAs in the BSS, or alternatively in some embodiments to a group of STA in the BSS. In that case, the AP must request a corresponding change of privacy level to all the STAs in the BSS or in the group of STA in the BSS. This may be done by having the AP broadcasting the privacy request action frame to all the other associated STAs in a step 530.

In another embodiment, the privacy request action frame is broadcasted by the AP to a group of STAs predefined by the AP. If a STA answers with a privacy response action frame rejecting the upgrade of the privacy level, the AP disassociates the STA from the BSS.

FIG. 6 illustrates the main steps of a method for modifying the privacy level by an AP in an embodiment of the invention. A request to modify the privacy level can be received from the upper layer on the AP side in a step 600. A privacy request action frame containing a set of PE parameters is sent in a step 610 by the AP. Similarly to the method described in relation with FIGS. 5a and 5b, when the station accepts the request, a privacy response action frame is sent by the solicited non-AP STAs. The set of PE parameters in the privacy response action frame is the new set of PE parameters requested by the AP. When the station refuses the change of privacy level, the former set of PE parameters, that continues to be used, is sent.

A change of privacy level requested by the upper layers of the AP may concern all the non-AP stations of the BSS, or at least a group of non-AP stations in the BSS. Accordingly, the request to change the privacy level may be broadcast to all the stations or addressed to the group of stations.

In some embodiments, when a station cannot answer positively to the request, the AP decides to de-associate this station.

The methods described in relation to FIGS. 3, 5a, 5b, and 6 are only examples of privacy management methods. In particular, the information elements and the action frames described in relation to FIGS. 2a, 2b, 2c, 2d and 4 may be used to implement any privacy policy in a BSS. The level of privacy and associated privacy policy may be required by either the AP or any non-AP station connected to the AP.

In some embodiments, the AP requires that a uniform level of privacy is applied in the BSS. In that case, any non-AP station that is not able to meet the required level of privacy is not accepted at the association stage, or de-associated if already associated.

In some embodiments, the AP may group the non-AP stations according to any criteria. For example, the stations may be grouped according to their capabilities, which may correspond to a generation of the standard or a technology that is implemented in the station (e.g. High-Efficiency, HE; Extremely High Throughput, EHT; etc.). In other embodiments, a group of stations may be constituted by stations that are identified as presenting a coherent movement. This may be the case of embedded devices such as devices hold by a user as his phone, his headset and a connected watch for example, all connected to a same AP. An AP may also group together stations identified as not moving in a first group and stations that are identified as moving in a second group.

Once the AP has created different groups of stations, it may require a uniform privacy level within each group. Alternatively, the AP may decide to manage virtual BSS, one for each group of station. In that case, a uniform level of privacy may apply to each virtual BSS managed by the AP.

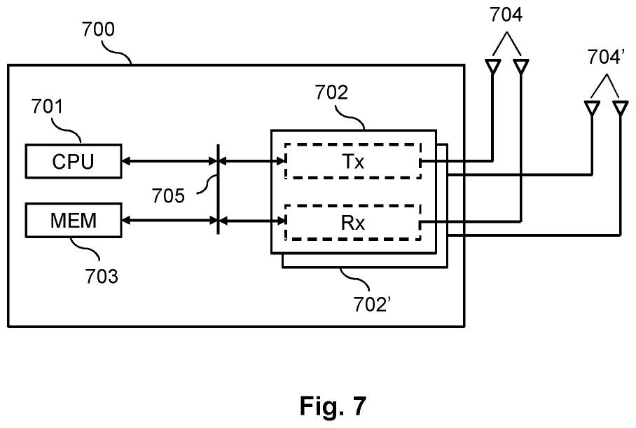

FIG. 7 illustrates an example of a communication device 700, typically any of the stations of FIG. 1, of a wireless network, configured to implement at least one embodiment of the present invention. The communication device 700 may preferably be a device such as a micro-computer, a workstation or a light portable device. The communication device 700 may comprise a communication bus 705 to which may be connected:
a central processing unit 701, such as a processor, denoted CPU;
a memory 703, denoted MEM, for storing an executable code of methods or steps of the methods according to embodiments of the invention as well as the registers adapted to record variables and parameters necessary for implementing the methods; and
at least two communication interfaces 702 and 702′ connected to the wireless communication network, for example a communication network according to one of the IEEE 802.11 family of standards, via transmitting and receiving antennas 704 and 704′, respectively.

Preferably the communication bus 705 may provide communication and interoperability between the various elements included in the communication device 700 or connected to it. The representation of the bus is not limiting and in particular the central processing unit is operable to communicate instructions to any element of the communication device 700 directly or by means of another element of the communication device 700.

The executable code may be stored in a memory that may either be read only, a hard disk or on a removable digital medium such as for example a disk. According to an optional variant, the executable code of the programs can be received by means of the communication network, via the interface 702 or 702′, in order to be stored in the memory 703 of the communication device 700 before being executed.

In an embodiment, the device 700 may be a programmable apparatus which uses software to implement embodiments of the invention. However, alternatively, embodiments of the present invention may be implemented, totally or in partially, in hardware (for example, in the form of an Application Specific Integrated Circuit or ASIC).

Any step of the algorithms of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

Each of the embodiments of the invention described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for managing a privacy level in a wireless network comprising an access point, AP, station and at least one non-AP station, the method comprising by a first station, either a non-AP station or the AP station:
sending to a second station a message comprising an information indicating a set of privacy enhancement, PE, parameters to be obfuscated, the set of PE parameters corresponding to a privacy level requested by the first station; and
receiving from the second station a response indicating whether the second station accepts the requested privacy level.

2. The method of claim 1, wherein the message further comprises an indication of the PE parameters supported by the first station.

3. The method of claim 1, wherein the information indicating a set of PE parameters is an information element comprising for each possible PE parameter an indication whether the PE parameter belongs to the set of PE parameters corresponding to the requested privacy level.

4. The method of claim 1, wherein the information indicating a set of PE parameters is an information element comprising for at least one privacy profile, a privacy profile corresponding to a set of PE parameters, whether the privacy profile corresponds to the requested privacy level.

5. The method of claim 1, wherein the message further comprises a privacy alignment indication indicating whether the requested privacy level must apply to the stations belonging to a group of stations connected to the AP station.

6. The method of claim 5, wherein the group of stations connected to the AP station comprises all the stations connected to the AP station.

7. The method of claim 1, wherein the first station is a non-AP station, the message is a management frame sent during the association of the non-AP station and the method further comprises:
receiving a message indicating the refusal of the association from the AP station when the AP does not accept the requested privacy level.

8. The method of claim 5, wherein:
the first station is a non-AP station;
the privacy alignment indication indicates that the requested privacy level must apply to the group of stations; and wherein the method further comprises by the AP station:
broadcasting a message requesting the requested privacy level to all the stations of the group of stations.

9. The method of claim 7, wherein the method further comprises by the AP station:
refusing the association of the first station when at least one station of the group of stations cannot meet the requested privacy level.

10. The method of claim 7, wherein the method further comprises by the AP station:
de-associating the stations in the group of stations that cannot meet the requested privacy level; and
accepting the association of the first station.

11. The method of any one claims 1 to 5, wherein:
the first station is the AP station; and
the message is an action frame.

12. The method of claim 10, wherein the method further comprises:
de-associating the second station when it cannot meet the requested privacy level.

13. A method for managing a privacy level in a wireless network comprising an access point, AP, station and at least one non-AP station, the method comprising by a station either a non-AP station or the AP station:
sending to another station a message comprising an information indicating a set of privacy enhancement, PE, parameters supported by the station.

14. (canceled)

15. A computer-readable storage medium storing instructions of a computer program for implementing a method according to claim 1.

16. (canceled)

17. A first station device for managing a privacy level in communication with a second station in a wireless network comprising an access point, AP, station and a non-AP station, the first station device being the non-AP station or the AP station, the first station device comprising a processor configured for:
sending to the second station a message comprising an information indicating a set of privacy enhancement, PE, parameters to be obfuscated, the set of PE parameters corresponding to a privacy level requested by the first station; and
receiving from the second station a response indicating whether the second station accepts the requested privacy level.

18. A station device for managing a privacy level in a wireless network comprising an access point, AP, station and at least one non-AP station, the station device being either a non-AP station or the AP station, the station device comprising a processor configured for:
sending to another station a message comprising an information indicating a set of privacy enhancement, PE, parameters supported by the station.

19-22. (canceled)
